(19) United States
(12) Patent Application Publication
(10) Pub. No.: US 2013/0085687 A1
(43) Pub. Date: Apr. 4, 2013

(54) METHOD AND DEVICE FOR DETERMINING THE FLOW RATE OF MAGNETIC OR FERROMAGNETIC PARTICLES AND USE OF SAID METHOD AND DEVICE

(71) Applicants: Vladimir Danov, Erlangen (DE); Helmut Eckert, Rottenbach (DE); Werner Hartmann, Weisendorf (DE); Manfred Rührig, Lauf a.d. Pegnitz (DE); Andreas Schröter, Anrode (DE); Roland Weiss, Erlangen (DE)

(72) Inventors: Vladimir Danov, Erlangen (DE); Helmut Eckert, Rottenbach (DE); Werner Hartmann, Weisendorf (DE); Manfred Rührig, Lauf a.d. Pegnitz (DE); Andreas Schröter, Anrode (DE); Roland Weiss, Erlangen (DE)

(21) Appl. No.: 13/702,730

(22) PCT Filed: Apr. 11, 2011
(86) PCT No.: PCT/EP11/55581

§ 371 Date: Dec. 7, 2012

(30) Foreign Application Priority Data
Jun. 9, 2010 (DE) 10 2010 023 129.0

(51) Int. Cl. G01P 5/08; G06F 19/00

(52) U.S. Cl. CPC G01P 5/08; G06F 19/00
USPC 702/45

(57) ABSTRACT

A method and a device for determining the flow rate of magnetic or ferromagnetic particles in a suspension that flows through control chambers are provided. The magnetic flux F1 is measured as a function of time t using a measuring coil that surrounds a first control chamber, the magnetic flux representing a measurement, at a particular time, of the quantity of magnetic particles contained in the suspension. In a second control chamber, at a predetermined distance d from the first control chamber, the magnetic flux F2 is measured as a function of time t using a second measuring coil that surrounds the second control chamber and the measurements F1 (t) and F2 (t) are compared to produce a temporal distance Δt which is used together with the predetermined distance d to calculate the flow rate. The method and device can be used, for example, in an ore mining installation.

### CROSS-REFERENCE TO RELATED APPLICATIONS

This application is a U.S. National Stage Application of International Application No. PCT/EP2011/055581 filed Apr. 11, 2011, which designates the United States of America, and claims priority to DE Patent Application No. 10 2010 023 129.0 filed Jun. 9, 2010 The contents of which are hereby incorporated by reference in their entirety.

### TECHNICAL FIELD

The present disclosure relates to a method and a device for determining the flow rate of magnetic or ferromagnetic particles in a suspension flowing through control chambers. The magnetic flux Φ₁ is measured as a function of time t using a measuring coil surrounding a first control chamber, wherein the magnetic flux at a point in time is a measure of the quantity of magnetic particles contained in the suspension. In a second control chamber, at a predetermined distance d from the first control chamber, the magnetic flux Φ₂ is measured as a function of time t using a second measuring coil surrounding the second control chamber. The present disclosure also applies to the use of the disclosed method and device.

### BACKGROUND

Magnetic or ferromagnetic particles are important in a number of technical processes. In medical diagnostics, for example, such particles are used for marking cells. Magnetic particles are likewise used in medical treatments (drug targeting).

Magnetic or ferromagnetic particles can also be used in water purification to precipitate particular substances from waste water. Another major field of application is the beneficiation of ores which are present as a suspension, mixed with water or some other liquid. The magnetic or ferromagnetic particles in the suspension can be separated using a magnetic field.

In the majority of applications it is desirable to know the quantity of the magnetic or ferromagnetic particles in order to be able to precisely control the method or process. Thus, for example, for the extraction of ores wherein the valuable material is recovered by flotation methods from the milled rock (ore), it is important because of the changing chemical composition of the rock and the valuable material concentration in the ore, to measure the flow rates and control them precisely in order to optimize the process. In particular, chemical parameters of the pulp must be continuously measured and re-adjusted.

In a newly developed method, non-magnetic ore particles are bonded to magnetizable particles by means of chemical surface activation so that these agglomerates can be extracted from the pulp using suitably formed magnetic fields. This new method provides a higher ore recovery rate with lower energy expenditure than the previous methods based on gas bubbles. However, these new methods require real-time control of flow rates and ore concentrations, particularly also of the magnetizable particles.

In conventional flotation, in particular two methods are used to determine the essential pulp parameters:
Rapid chemical analysis with time rastering which typically requires a few minutes.
X-ray based analysis (X-fluorescence or rather X-absorption).

As the chemical analyses are based on the fact that in general large quantities of material are reacted, thereby producing a strongly averaging effect, it is unsuitable for detecting chronologically, and with sufficient accuracy in respect of the concentration, short-term fluctuations which may be an issue e.g. in a magnetic separator.

Although X-ray based analysis methods are state of the art and are also able to detect in particular short-term fluctuations sufficiently accurately, they have the significant disadvantage that radiation monitoring areas must therefore be set up in the production area which are disadvantageous in terms of safety and cost.

Other methods or the kind normally used to measure flow volumes and flow velocities in real time are based on moving mechanical components that would quickly be subject to wear owing to the abrasive properties of the pulp. With these methods it is also impossible to measure the proportion of magnetic or ferromagnetic particles in the total quantity of liquid and differentiate them from other particles, e.g. sand,

### SUMMARY

In one embodiment, a method is provided for determining the flow rate of magnetic or ferromagnetic particles in a suspension flowing through control chambers, wherein the magnetic flux Φ₁ is measured as a function of time t using a measuring coil surrounding a first control chamber, wherein the magnetic flux at a point in time is a measure of the quantity of magnetic particles contained in the suspension, and, in a second control chamber at a predetermined distance d from the first control chamber, the magnetic flux Φ₂ is measured as a function of time t using a second measuring coil surrounding the second control chamber, characterized in that a comparison of the measurements Φ₁ (t) and Φ₂ (t) produces a time interval Δt which is used to calculate the flow rate using the predetermined distance d.

In a further embodiment, the concentration c of magnetic or ferromagnetic particles in a suspension is calculated from the flow rate, the cross-sectional area of the flow and a magnetic flux Φ as a function of time t. In a further embodiment, a distinctive measuring point P at an instant ti is determined from the measurement curve of the magnetic flux Φ₁ as a function of time t, in particular a maximum or minimum of the value of the magnetic flux Φ₁ at the instant t₁, which measuring point is detected again in the measurement curve of the magnetic flux Φ₂ as a function of time t at an instant t₂, in particular as a corresponding maximum or minimum of the value of the magnetic flux Φ₂ at the instant t₂, wherein the time difference between the instants t₁ and t₂ yields the time interval Δt which gives the flow rate as the quotient of the predefined distance d divided by the time interval Δt. In a further embodiment, the magnetic particles are magnetized using a magnetic field generating device disposed upstream of the measuring coils. In a further embodiment, the magnetic field generating device produces a static magnetic field which acts on the measuring coils. In a further embodiment, the magnetic flux in a control chamber is measured over a defined integration time using a fluxmeter. In a further embodiment, the magnetic field generating device produces a time-varying magnetic field in the control chambers. In a further embodiment, the flux is measured in each control chamber on the basis of the induced voltage in the measuring coil assigned to the control chamber. In a further embodiment, in each case two coils are interconnected in a diametrically opposed manner as a measuring coil in order to compensate the magnetic flux of the magnetic field generating device by the diametrically opposed connection. In a further embodiment, a magnetic flux Φ can be measured as a function of time t using more than two measuring coils surrounding a control chamber.

In another embodiment, a device is provided for determining the flow rate of magnetic or ferromagnetic particles in a suspension for carrying out any of the methods disclosed above.

In another embodiment, a method or device as disclosed above is used in an ore extraction plant.

### BRIEF DESCRIPTION OF THE DRAWINGS

Example embodiments will be explained in more detail below with reference to figures, in which:

FIG. 1 shows the setup of a measuring arrangement for measuring magnetic particles using a measuring coil and a magnetic field generating device which produces a static magnetic field,

FIG. 2 shows the measuring arrangement illustrated in FIG. 1, but having a magnetic field generating device which produces a time-varying magnetic field,

FIG. 3 shows a schematic diagram of the measuring setup for carrying out an example method for determining the flow rate of magnetic or ferromagnetic particles, and

FIG. 4A-C shows a schematic diagram of a step of the example method, based on the comparison of the two measurement curves A and B.

### DETAILED DESCRIPTION

Some embodiments specify a method and a device for determining the flow rate of magnetic or ferromagnetic particles which solve the problems described above. In particular, some embodiments measure the flow rate of the magnetic or ferromagnetic particles in a contactless and thus wear-free manner, but nevertheless reliably. In particular, some embodiments measure only magnetic or ferromagnetic particles, and not larger or smaller non-magnetic particles, and determine the concentration from the flow rate without having to use hazardous radiation such as X-rays, for example. This may reduce cost and complexity and makes better process control possible. Other embodiments specify a use of the method and device.

Some embodiments of the method for determining the flow rate of magnetic or ferromagnetic particles will emerge from the associated dependent sub-claims. The features of the main claims can be combined with one another and with features of the sub-claims, and features of the sub-claims can also be combined with one another.

The method for determining the flow rate of magnetic or ferromagnetic particles in a suspension flowing through control chambers involves measuring the magnetic flux Φ₁ as a function of time t using a measuring coil surrounding a first control chamber. The magnetic flux at a point in time is a measure of the quantity of magnetic particles contained in the suspension. In addition, in a second control chamber at a predetermined distance d from the first control chamber, the magnetic flux Φ₂ is measured as a function of time t using a second measuring coil surrounding the second control chamber. Comparison of the measurements Φ₁ (t) and Φ₂ (t) yields a time interval Δt which is used to determine the flow rate using the predetermined distance d.

The use of measuring coils which measure a magnetic flux allows contactless, wear-free determination of the flow rate of magnetic or ferromagnetic particles, without X-ray radiation, thereby eliminating frequent replacement of parts subject to wear, and therefore saving costs. In addition, the high cost/complexity associated with the use of X-ray radiation is avoided. Comparison of two measurement curves obtained as a function of time via two measuring coils allows reliable determination of the time required by magnetic or ferromagnetic particles in a suspension to travel a predetermined distance d. The thereby determined flow rate which is ascertained at each point in time simultaneously with the flow can be used for closed- or open-loop process control.

The concentration c of magnetic or ferromagnetic particles in a suspension can be calculated from the flow rate v, the cross-sectional area of the flow A and a magnetic flux Φ as a function of time t. The concentration c is given as the quotient of the number of particles n divided by the volume V. The magnetic flux Φ₁ measured by the measuring coil is a measure of the quantity of magnetic particles contained in the suspension n at an instant t₁. If the magnetic flux is measured over a time interval Δt, this gives the number of magnetic particles n that have passed through the measuring coil in that time interval Δt. In the same time interval, the liquid, i.e. the suspension, will have traveled a distance s(Δt) with a flow rate v, assuming a uniform flow with constant flow rate v. This yields a volume V of suspension that has flowed through a measuring coil in a time interval Δt of s(Δt) multiplied by the cross-sectional area A of the flow. The cross-sectional area of the flow A is, for example, the internal cross-section of a tube around which the measuring coil is positioned and through which the suspension flows.

Therefore, the flow rate v having been measured, the volume V(Δt) flowing through the measuring coil in a time AΔt is known. Simultaneously known is the particle count n(Δt), measured via the magnetic flux, that has passed through the measuring coil in the volume V(Δt). This yields the concentration c as the quotient of particle count n(Δt) divided by volume V(Δt). Online monitoring of the concentration c is therefore possible using the disclosed method.

Compared to using a single measuring coil, the use of two measuring coils spaced a predefined distance d apart, and the comparison of the time characteristic of the magnetic flux through the two measuring coils, allows reliable calculation of the flow velocity v even if the particle count or rather concentration is unknown. The prompt comparison of the measurement curves and the flow velocity v and concentration c calculated therefrom can take place in an automated manner by computer and be used for controlling processes in real time.

From the measurement curve of the magnetic flux Φ₁ as a function of time t, a distinctive measuring point P at an instant ti can be determined, in particular a maximum or minimum of the value of the magnetic flux Φ₁ at the instant t₁. This can be recognized by comparison with the measurement curve of the magnetic flux Φ₂ as a function of time t at an instant t2, in particular as a corresponding maximum or minimum of the value of the magnetic flux Φ₂ at the instant t₂. The time difference between the instants t₁ and t₂ then yields the time interval Δt which yields the flow rate as the quotient of the predetermined distance d divided by the time interval Δt.

The magnetic particles can be magnetized using a magnetic field generating device disposed upstream of the measuring coils. Previously magnetized particles or particles already present in magnetized form do not need to be magnetized.

In one embodiment, the magnetic field generating device can produce a static magnetic flux which permeates the measuring coils. Said magnetic flux can be measured in a control chamber over a fixed integration time using a fluxmeter. For the measurement of the magnetic fluxes in the two control chambers using fluxmeters it is required that the magnetic field of the magnetic field generating device be extended to the two control chambers.

As an alternative to the above described method using a static magnetic field, the magnetic field generating device can produce a time-varying magnetic field in the control chambers. The magnetic flux in a control chamber can then be measured on the basis of the induced voltage in the measuring coil assigned to the control chamber.

Two coils can be connected in a diametrically opposed manner as a measuring coil system. The diametrically opposed connection enables the magnetic flux of the magnetic field generating device to be compensated.

More than two measuring coils or rather measuring coil systems can be used. By means of the more than two measuring coils surrounding a control chamber, a magnetic flux Φ can be measured as a function of time t in each case, and comparison of more than two measurement curves can result in more reliable identification of extreme measuring points P. This enables time intervals Δt in which time-discrete measuring points P are measured at the respective two measuring coils, the flow velocity and the concentration to be determined with greater reliability and accuracy, e.g. by averaging of measured values.

A device for determining the flow rate of magnetic or ferromagnetic particles in a suspension can be used to carry out the method described above. This device generally comprises two or more measuring coils each disposed at a predetermined distance from one another around the respective control chamber assigned to the measuring coil, wherein the control chambers are in the flow path of the suspension containing magnetic or ferromagnetic particles.

In other embodiments, the above described method and/or above described device is used in an ore extraction plant.

Certain advantages associated with the device for determining the flow rate of magnetic or ferromagnetic particles in a suspension and the advantages associated with using the method and device may be analogous to the advantages described above with reference to the method for determining the flow rate of magnetic or ferromagnetic particles in a suspension.

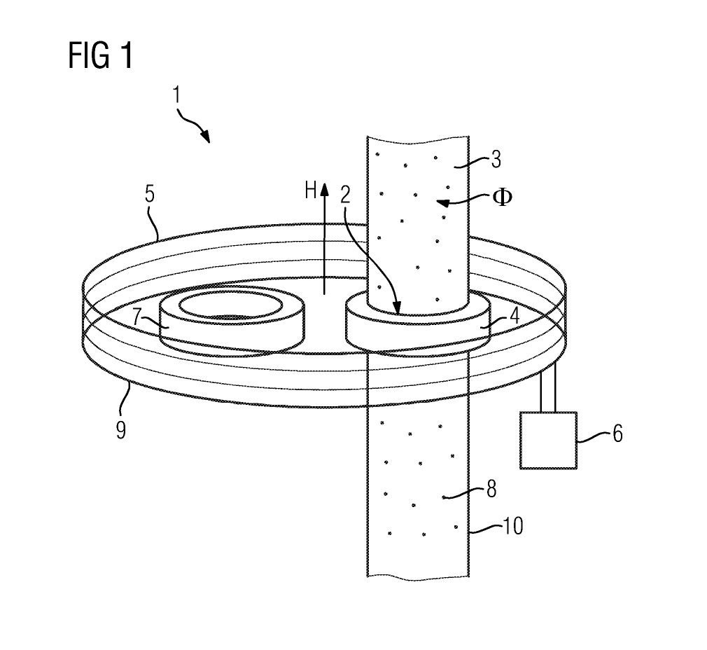

The device 1 shown in FIG. 1 comprises a tubular control chamber 2 through which a suspension 3 containing magnetic or magnetizable particles flows. The control chamber 2 is surrounded by a measuring coil 4 which measures the magnetic flux inside the area enclosed by the measuring coil 4. The control chamber 2 is also surrounded by a magnetic field generating device implemented as a coil 5 (excitation coil) through which a field current flow which produces a static magnetic field in the control chamber. The number of turns of the coil 5 and the current flowing through the coil 5 are selected such that the magnetic field H inside the coil 5 is large enough to magnetize ferromagnetic particles contained in the suspension 3 up to a specified value. The ferromagnetic particles are magnetized by the static magnetic field produced by the coil 5, resulting in an additional magnetic flux B_{M} which is detected by integration with respect to time using the measuring coil 4 and a thereto connected fluxmeter 6 represented merely schematically in FIG. 1, wherein the measurement signal is a measure of the ferromagnetic particles present in the measuring coil 4 during the integration time.

As the measuring coil 4 measures not only the magnetic flux B_{M} caused by the ferromagnetic particles but also the magnetic flux B_{H} caused by the coil 5 or more specifically by the excitation field H (so-called air flux B_{H}=μ₀H), a compensating coil 7 is located within the excitation field inside the coil 5. The compensating coil 7 is disposed such that it is likewise permeated by the air flux B_{H} of the field coil, but not by the magnetic flux B_{M} of the magnetic particles passing through the control chamber 2. In respect of its enclosed area and the number of turns per unit length, the compensating coil 7 is implemented such that it is a precise mirror image of the measuring coil 4. This is achieved e.g. in that, while the two coils have the same number of turns and the same coil surface area, the winding sense is opposite. In the exemplary embodiment shown in FIG. 1, the compensating coil 7 is disposed alongside the measuring coil 4. The compensating coil 7 and the diametrically opposed measuring coil 4 are connected electrically in series, so that in the aggregate signal of the two coils the flux of the exciting field B_{H} permeating the two coils is precisely compensated (net voltage U=0). This means that the time integral picked up by the connected fluxmeter 6 is likewise zero. If magnetizable or magnetized particles are present in the control chamber or more specifically in the measuring coil surrounding it, the compensation of the coil arrangement comprising measuring coil (4) and compensating coil (7) is disturbed and the magnetic flux B_{M} caused by the magnetization of the particles contributes to a net voltage U≠0 which is integrated with respect to time by the connected fluxmeter. The integrated voltage U therefore constitutes a measure of the magnetization and therefore a measure of the quantity of magnetic or magnetizable particles contained in the suspension and can be used as a controlled variable in a process control system.

Within the scope of the method for magnetic separation, the proportion of magnetic or magnetizable particles contained in the suspension can be determined using the measurement signal.

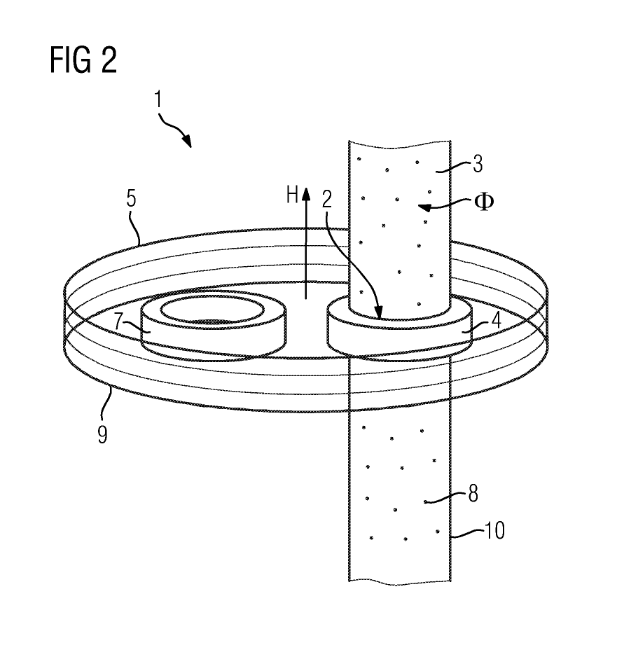

FIG. 2 shows a second exemplary embodiment, wherein the same reference characters as in FIG. 1 are used to denote equivalent components. As in the first exemplary embodiment, a device 8 comprises a tubular control chamber 2 through which a suspension 3 flows and which is surrounded by a measuring coil 4. In contrast to the first exemplary embodiment, a magnetic field generating device implemented as a coil 9 produces an alternating magnetic field which alternately magnetizes the ferromagnetic particles contained in the suspension 3 in the reverse direction at a defined frequency. The alternating magnetic field causes the ferromagnetic particles inside the measuring coil 4 to be continuously re-magnetized, so that the additional magnetic flux B_{M}˜ produced by the magnetic particles changes periodically with the frequency of the alternating magnetic field used as the excitation field. The variation over time of the magnetic flux causes a voltage to be induced in the measuring coil 4 which is proportional to the variation in the magnetic flux and therefore constitutes a measure of the proportion of magnetic or magnetizable particles in the measuring coil 4.

As in the first exemplary embodiment, there is disposed inside the coil 9 producing the excitation field a compensating coil 7 implemented e.g. as the mirror image of the measuring coil in order to compensate the effect of the excitation field on the measuring coil 4.

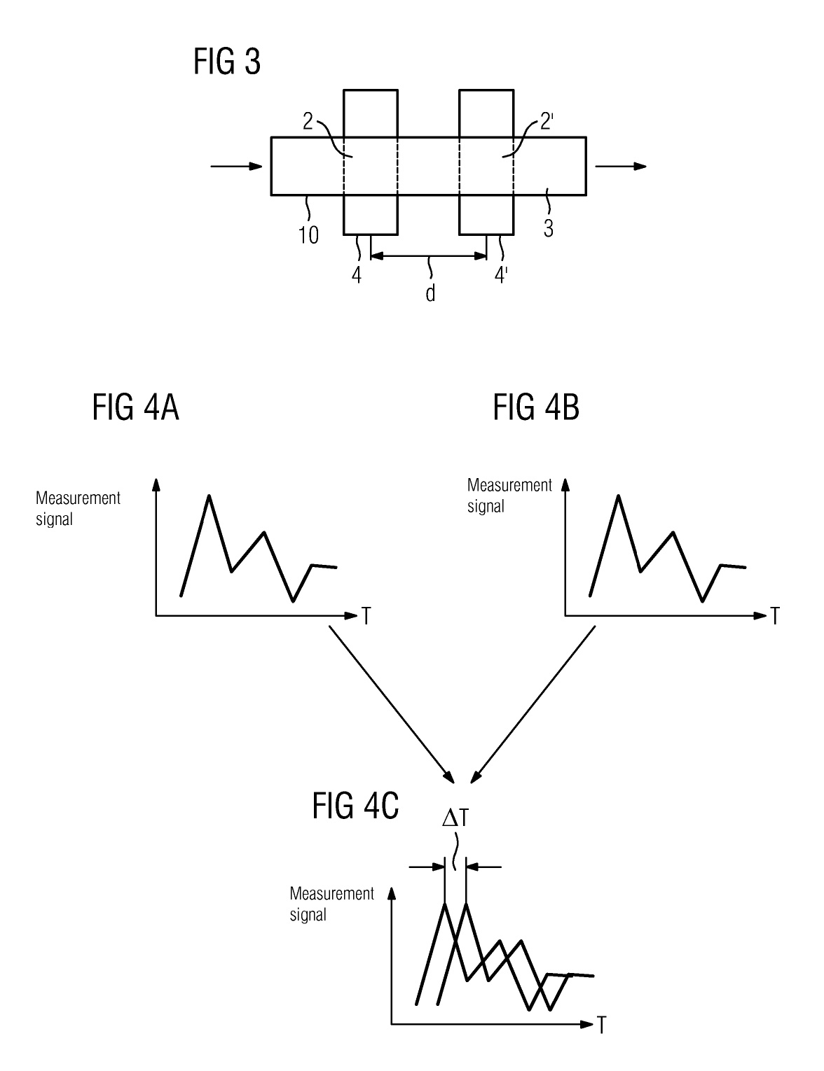

FIG. 3 shows a schematic diagram of the measurement setup for carrying out the disclosed method. Two control chambers 2, 2′, each surrounded by a measuring coil 4, 4′, are disposed in series along the flow path of a suspension 3 to determine the flow rate of magnetic or magnetizable particles. The suspension flows in a flow passage 10 comprising, e.g., a tube made of plastic or some other non-magnetizable material. The measuring coils 4, 4′, as described above, are each disposed around the tube at a predetermined distance d from one another. The tube cross-sectional area through which the suspension 3 flows and which is completely encircled by the coil is the cross-sectional area of the flow A. It lies in the plane of a coil winding and perpendicular to the longitudinal axis of the coil.

The suspension 3 of e.g. water and magnetic or magnetizable particles 8 flows through the flow passage 10 and passes through the first control chamber 2. The control chamber 2 is surrounded by an above described measuring coil 4 or more precisely a measuring device 1 as described above in FIGS. 1 and 2 is disposed at the location of the control chamber 2.

As shown in FIG. 4A, a measurement signal, e.g. a measurement voltage U, is determined as a function of time by the first measuring coil 4. This voltage U at an instant t is a measure of the magnetic flux Φ₁ at said instant t and therefore a measure of the quantity of magnetic particles 8 contained in the suspension 3 that are moving through the measuring coil 4 at the instant t.

Similarly, as shown in FIG. 4B, a measurement signal, e.g. a measurement voltage U′, is determined as a function of time by the second measuring coil 4′. This voltage U′ at an instant t is a measure of the magnetic flux Φ₂ at that instant t and therefore a measure of the quantity of magnetic particles 8 contained in the suspension 3 that are moving through the measuring coil 4′ at the instant t.

As a magnetic particle 8 in the suspension 3 is moved through the measuring coil 4 at an instant t₁, and is moved, flowing on with the suspension 3, through the measuring coil 4′ at an instant t₂, it is measured by the two measuring coils 4, 4′ with a time difference of Δt. Similarly, the quantity of magnetic particles 8 in the suspension 3 which are moved through the measuring coil 4 at an instant t₁ are moved, flowing on with the suspension 3, through the measuring coil 4′ and measured at an instant t₂. The time difference of Δt is the time taken by the magnetic particles 8 in the suspension 3 to flow from the measuring coil 4 to the measuring coil 4′, i.e. to cover the distance which is the predetermined distance d.

As the concentration of the magnetic particles 8 in the suspension 3 changes, a measurement at the measuring coil 4 produces a measurement curve, e.g. U(t), see also FIG. 4A, which is repeated with a time difference Δt for the measurement at the measuring coil 4′, see FIG. 4B.

If, as shown in FIG. 4C, the measurements of the two measuring coils 4, 4′ are compared with one another, the time difference Δt can be determined using the signature, i.e. shape, of the measurement curves. For example, a distinctive maximum in the measurement curve of the measuring coil 4 can be detected in the measurement curve of the measuring coil 4′ on the basis of its shape, and the time difference between the appearance of the maximum in the measurement curve of the measuring coil 4 and the measurement curve in the measuring coil 4′ can be determined. This time difference is represented by Δt. For this purpose, the measurement curves of FIGS. 4A and 4B can be represented in a superimposed manner in a graph as shown in FIG. 4C, wherein they are superimposed such that, on the time axis, the points on the curve that were measured at the same time using the measuring coil 4 and the measuring coil 4′ are assigned the same value on the time axis.

The above described method can also be carried out electronically or by a computer. Thus, the difference between the measured voltages can be determined and analyzed by an electronic circuit, for example. Using a computer program, a flow rate v can be simultaneously calculated by determining the time difference Δt, via the formula

v(t)=d/Δt

where v(t) is the average flow rate, d the predetermined distance between the control chambers or more precisely measuring coils 4 and 4′, and Δt the calculated time difference between the measurement of a distinctive point on the measurement curve of the measuring coil 4 and the same distinctive point on the measurement curve of the measuring coil 4′.

The concentration c of magnetic or ferromagnetic particles 8 in a suspension 3 can be calculated in a time-dependent manner from the average flow rate v(t), the cross-sectional area of the flow A and a magnetic flux φ as a function of time t. The concentration c is given as the quotient of the number of particles n divided by the volume V. The magnetic flux Φ₁ measured by the measuring coil 4 is, at an instant t₁, a measure of the quantity n of magnetic particles 8 contained in the suspension 3. If the magnetic flux is measured over a time interval Δt, the quantity of magnetic particles 8 that have passed through the measuring coil in that time interval Δt is given by the number n. In the same time interval, the liquid, i.e. the suspension 3 having a flow rate v, will have covered a distance s(Δt), assuming a uniform flow with constant flow rate v in the brief time interval. This yields a volume V of suspension 3 that has flowed through a measuring coil 4 in a time interval Δt of s(Δt) multiplied by the cross-sectional area A of the flow. The cross-sectional area of the flow A is, for example, the internal cross section of a tube surrounded by the measuring coil and through which the suspension 3 flows.

With a measured flow rate v (=const), the volume V(Δt) flowing through the measuring coil 4 in a time Δt is therefore known. Simultaneously known is the number of particles n(Δt), measured by the magnetic flux Φ, that have passed through the measuring coil with the volume V(Δt). This yields the concentration c as the quotient of particle count n(Δt) divided by volume V(Δt).

c=n(Δt)/V(Δt)=n(Δt)/(s(Δt)×A)=n(Δt)/(d×A)

where n(Δt) ˜Φ, i.e. the particle count proportional to the measured magnetic flux.

Online monitoring of the flow rate v and concentration c of magnetic or magnetizable particles 8 in a suspension 3 is therefore possible using the disclosed method.

The invention is not limited to the exemplary embodiments described in the foregoing. Combinations of the above described exemplary embodiments are likewise possible. Materials other than those described above, such as e.g. suspensions of oil, blood or other liquids, are also possible.

What is claimed is:

1. A method for determining a flow rate of magnetic or ferromagnetic particles in a suspension flowing through control chambers, comprising:
measuring a first magnetic flux Φ₁ as a function of time t as a function Φ₁ (t) using a first measuring coil surrounding a first control chamber, wherein the magnetic flux at a point in time is a measure of the quantity of magnetic particles contained in the suspension,
in a second control chamber arranged at a
predetermined distance d from the first control chamber, measuring a second magnetic flux Φ₂ as a function of time t as a function Φ₂ (t) using a second measuring coil surrounding the second control chamber,
comparing the first measured flux function Φ₁ (t) with the second measured flux function Φ₂ (t) to determine a time interval Δt, and
using the determined time interval Δt and a predetermined distance d to calculate the flow rate of magnetic or ferromagnetic particles in the suspension flowing through the control chambers.

2. The method of claim 1, comprising calculating a concentration c of magnetic or ferromagnetic particles in the suspension based on the calculated flow rate, a cross-sectional area of the flow, and a magnetic flux Φ as a function of time t.

3. The method of claim 1, comprising:
determining a distinctive measuring point based on a maximum or minimum of the value of the first magnetic flux Φ₁ at a first instant t₁, which measuring point is further detected as a corresponding maximum or minimum of the value of the second magnetic flux Φ₂ at a second instant t₂,
determining the time interval Δt based on a time difference between the instants t₁ and t₂.

4. The method of claim 1, wherein the magnetic particles are magnetized using a magnetic field generating device located upstream of the first and second measuring coils.

5. The method of claim 4, wherein the magnetic field generating device produces a static magnetic field that acts on the first and second measuring coils.

6. The method of claim 5, wherein at least one of the first and second magnetic flux is measured over a defined integration time using a fluxmeter.

7. The method of claim 4, wherein the magnetic field generating device produces a time-varying magnetic field in the control chambers.

8. The method of claim 7, wherein the magnetic flux is measured in each control chamber based on an induced voltage in the respective measuring coil assigned to that control chamber.

9. The method of claim 4, wherein two coils are interconnected in a diametrically opposed manner as a measuring coil in order to compensate the magnetic flux of the magnetic field generating device by the diametrically opposed connection.

10. The method of claim 1, wherein a magnetic flux Φ is measured as a function of time t using more than two measuring coils surrounding a control chamber.

11. device for determining the flow rate of magnetic or ferromagnetic particles in a suspension, comprising:
a first measuring coil surrounding a first control chamber and configured to measure a first magnetic flux Φ₁ as a function of time t as a function Φ₁ (t), wherein the magnetic flux at a point in time is a measure of the quantity of magnetic particles contained in the suspension,
a second measuring coil surrounding a second control chamber arranged at a predetermined distance d from, the first, control chamber, the second measuring coil configured to measure a second magnetic flux Φ₂ as a function of time t as a function Φ₂ (t),
a processor configured to:
compare the first measured flux function Φ₁ (t) with the second measured flux function Φ₂ (t) to determine a time interval Δt, and
calculate a flow rate of magnetic or ferromagnetic particles in the suspension based on the determined time interval Δt and a predetermined distance d.

12. (canceled)

13. The device of claim 11, wherein the processor is further configured to calculate a concentration c of magnetic or ferromagnetic particles in the suspension based on the calculated flow rate, a cross-sectional area of the flow, and a magnetic flux Φ as a function of time t.

14. The device of claim 11, wherein the processor is further configured to:
determine a distinctive measuring point based on a maximum or minimum of the value of the first magnetic flux Φ₁ at a first instant t₁, which measuring point is further detected as a corresponding maximum or minimum of the value of the second magnetic flux Φ₂ at a second instant t₂,
determine the time interval Δt based on a time difference between the instants t₁ and t₂.

15. The device of claim 11, comprising a magnetic field generating device configured to magnetize the magnetic particles, the magnetic field generating device located upstream of the first and second measuring coils.

16. The device of claim 15, wherein the magnetic field generating device produces a static magnetic field that acts on the first and second measuring coils.

17. The device of claim 15, wherein the magnetic field generating device produces a time-varying magnetic field in the control chambers.

18. The device of claim 16, comprising at least one fluxmeter configured to measure at least one of the first and second magnetic flux over a defined integration time.

19. The device of claim 11, wherein the magnetic flux is measured in each control chamber based on an induced voltage in the respective measuring coil assigned to that control chamber.

20. The method of claim 15, comprising coils interconnected in a diametrically opposed manner as a measuring coil configured to compensate the magnetic flux of the magnetic field generating device by the diametrically opposed connection.
